(19) United States
(12) Patent Application Publication
(10) Pub. No.: US 2017/0060591 A1
(43) Pub. Date: Mar. 2, 2017

(54) SYSTEM AND METHOD FOR MULTI-BRANCH SWITCHING

(71) Applicant: Huawei Technologies Co., Ltd., Longgang (CN)

(72) Inventors: Peter Man-Kin SINN, Nepean (CA); Chang LEE, Montreal (CA); Louis-Philippe HAMELIN, Montreal (CA)

(21) Appl. No.: 14/949,204

(22) Filed: Nov. 23, 2015

Related U.S. Application Data
(60) Provisional application No. 62/210,249, filed on Aug. 26, 2015.

(51) Int. Cl. G06F 9/30; G06F 9/38

(52) U.S. Cl. CPC G06F 9/30061; G06F 9/3802

(57) ABSTRACT

A system and method for multi-branch switching are provided. A memory has stored therein a program comprising at least one sequence of instructions, the at least one sequence of instructions comprising a plurality of branch instructions, at least one branch of the program reached upon execution of each one of the plurality of branch instructions. The processor is configured for fetching the plurality of branch instructions from the memory, separately buffering each branch of the program associated with each one of the fetched branch instructions, evaluating the fetched branch instructions in parallel, and executing the evaluated branch instructions in parallel.

### CROSS-REFERENCE TO RELATED APPLICATIONS

This application claims priority under 35 U.S.C. 119(e) of U.S. Provisional Patent Application No. 62/210,249, filed on Aug. 26, 2015 and entitled “System and Method for Multi-Branch Switching”, the contents of which are hereby incorporated by reference.

### FIELD

Embodiments described herein generally relate to the field of processors, and more particularly, to multi-branch processors.

### BACKGROUND

Processors typically execute instructions in the sequence they appear in a program to be executed. Nevertheless, when conditional branch or jump instructions are reached, the processor may be caused to begin execution of a different part of the program rather than executing the next instruction in the sequence. In order to minimize execution stalls, some processors speculatively execute branch instructions by predicting whether a given branch of the program will be taken. Stalls in the processor's execution pipeline can then be avoided if the given branch is subsequently resolved as correctly predicted. However, mispredicted branches result in program discontinuities that require instruction flushes to revert the processor's context back to the state before the discontinuities and program execution may therefore be delayed. Therefore, since it is common for a program to contain several conditional branch or jump instructions, a significant portion of the overall program runtime can be wasted because of program discontinuities and branch switching, thereby negatively affecting processor performance.

Therefore, there is a need for an improved multi-branch processor.

### SUMMARY

In accordance with one aspect, a system comprises a memory having stored therein a program comprising at least one sequence of instructions, the at least one sequence of instructions comprising a plurality of branch instructions, at least one branch of the program reached upon execution of each one of the plurality of branch instructions, and a processor configured for fetching the plurality of branch instructions from the memory, separately buffering each branch of the program associated with each one of the fetched branch instructions, evaluating the fetched branch instructions in parallel, and executing the evaluated branch instructions in parallel.

In accordance with another aspect, a system comprises a memory having stored therein a program comprising at least one sequence of instructions, the at least one sequence of instructions comprising a plurality of branch instructions, at least one branch of the program reached upon execution of each one of the plurality of branch instructions, and a processor comprising a fetching unit configured to fetch the plurality of branch instructions from the memory and separately buffer each branch of the program associated with each one of the fetched branch instructions; an instruction evaluating unit configured to evaluate the fetched branch instructions in parallel; and a control unit configured to route the evaluated branch instructions to an execution unit for parallel execution.

In some example embodiments, the processor may be configured for resolving each condition upon which the evaluated branch instructions depend and accordingly identifying, upon resolving the condition, ones of the plurality of branch instructions that are not to be taken and one of the plurality of branch instructions to be taken.

In some example embodiments, the processor may be configured for discarding the ones of the plurality of branch instructions not to be taken and carrying on with execution of the one of the plurality of branch instructions to be taken.

In some example embodiments, the processor may be configured for preventing further evaluation of the ones of the plurality of branch instructions that are not to be taken.

In some example embodiments, the system may further comprise a First-In-First-Out (FIFO) buffer having a multi-page construct and the processor may be configured for buffering each branch of the program as an individual page of the buffer.

In some example embodiments, the processor may be configured for determining a size of the buffer and fetching a limited number of the plurality of branch instructions from the memory, the number determined in accordance with the size of the buffer.

In some example embodiments, the processor may be configured for determining a type of each one of the plurality of branch instructions, identifying selected ones of the plurality of branch instructions resulting in a program discontinuity upon the at least one branch of the program being reached, and storing resource allocation and register information associated with each selected one of the plurality of branch instructions in a corresponding page of the buffer.

In some example embodiments, the at least one sequence of instructions may comprise at least one pre-branch instruction to be executed before the at least one branch of the program is reached and at least one post-discontinuity instruction to be executed after occurrence of the program discontinuity, and the processor may be configured for retrieving the stored resource allocation and register information and proceeding with execution of the at least one post-discontinuity instruction in accordance with the retrieved resource allocation and register information.

In some example embodiments, the processor may be configured for proceeding with execution of the at least one post-discontinuity instruction comprising identifying from the resource allocation and register information a result of the at least one pre-branch instruction as being an input operand for the at least one post-discontinuity instruction and a temporary register as having stored therein the pre-branch instruction result, retrieving the pre-branch instruction result from the temporary register, and providing the pre-branch instruction result as input to the at least one post-discontinuity instruction.

In accordance with another aspect, a method of operating a processor is provided comprising fetching a plurality of branch instructions from a memory, at least one branch of a program reach upon execution of each one of the plurality of branch instructions; separately buffering each branch of the program associated with each one of the fetched branch instructions; evaluating the fetched branch instructions in parallel; and executing the evaluated branch instructions in parallel.

In some example embodiments, the method may further comprise resolving each condition upon which the evaluated branch instructions depend and accordingly identifying, upon resolving the condition, ones of the plurality of branch instructions that are not to be taken and one of the plurality of branch instructions to be taken.

In some example embodiments, the method may further comprise discarding the ones of the plurality of branch instructions not to be taken and carrying on with execution of the one of the plurality of branch instructions to be taken.

In some example embodiments, the method may further comprise preventing further evaluation of the ones of the plurality of branch instructions that are not to be taken.

In some example embodiments, separately buffering each branch of the program associated with each one of the fetched branch instructions may comprise buffering each branch of the program as an individual page of a First-In-First-Out (FIFO) buffer having a multi-page construct.

In some example embodiments, the method may further comprise determining a size of the buffer and fetching the plurality of branch instructions may comprise fetching a limited number of the plurality of branch instructions from the memory, the number determined in accordance with the size of the buffer.

In some example embodiments, the method may further comprise determining a type of each one of the plurality of branch instructions, identifying selected ones of the plurality of branch instructions resulting in a program discontinuity upon the at least one branch of the program being reached, and storing resource allocation and register information associated with each selected one of the plurality of branch instructions in a corresponding page of the buffer.

In some example embodiments, the method may further comprise retrieving the stored resource allocation and register information and proceeding with execution of at least one post-discontinuity instruction in accordance with the retrieved resource allocation and register information, the at least one post-discontinuity instruction executed after occurrence of the program discontinuity.

In some example embodiments, proceeding with execution of the at least one post-discontinuity instruction may comprise identifying from the resource allocation and register information a result of at least one pre-branch instruction as being an input operand for the at least one post-discontinuity instruction, the at least one pre-branch instruction to be executed before the at least one branch of the program is reached, and a temporary register as having stored therein the pre-branch instruction result, retrieving the pre-branch instruction result from the temporary register, and providing the pre-branch instruction result as input to the at least one post-discontinuity instruction.

In accordance with yet another aspect, there is provided a non-transitory computer readable medium having stored thereon program code executable by a processor for fetching a plurality of branch instructions from a memory, at least one branch of a program reach upon execution of each one of the plurality of branch instructions; separately buffering each branch of the program associated with each one of the fetched branch instructions; evaluating the fetched branch instructions in parallel; and executing the evaluated branch instructions in parallel.

The non-transitory computer-readable media comprise all computer-readable media, with the sole exception being a transitory, propagating signal.

Many further features and combinations thereof concerning the present improvements will appear to those skilled in the art following a reading of the instant disclosure.

### DESCRIPTION OF THE FIGURES

In the figures,

FIG. 1 is a schematic diagram of a context switching multi-branch processor, in accordance with one embodiment;

FIG. 2 is a schematic diagram detailing the instruction memory, the pre-execution instruction pipeline, and the execution unit of FIG. 1, in accordance with one embodiment;

FIG. 3 is a flowchart of a method for operating the processor of FIG. 1, in accordance with one embodiment;

FIG. 4 is a flowchart of the step of FIG. 3 of fetching instructions, in accordance with one embodiment;

FIG. 5 is a flowchart of the step of FIG. 3 of managing resource allocation, in accordance with one embodiment;

FIG. 6 is a flowchart of the step of FIG. 3 of executing instructions, in accordance with one embodiment;

FIG. 7 is a flowchart of the step of FIG. 6 of executing branch instructions, in accordance with one embodiment; and

FIG. 8 is a schematic diagram of execution of an instruction stream using the processor of FIG. 1, in accordance with one embodiment.

It will be noted that throughout the appended drawings, like features are identified by like reference numerals.

### DETAILED DESCRIPTION

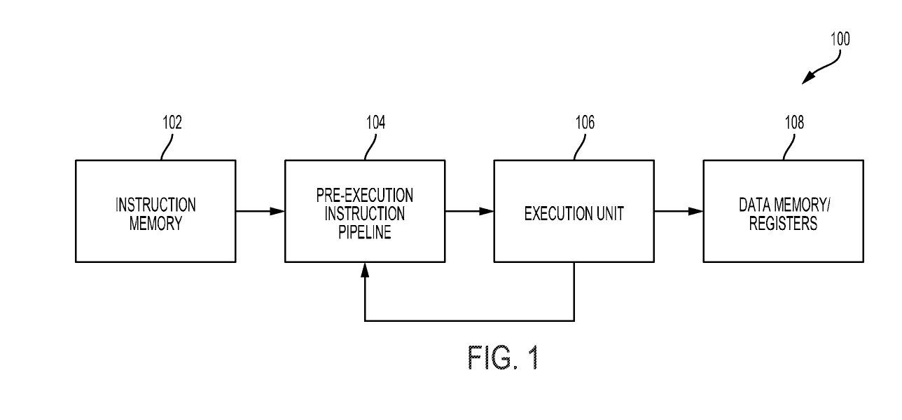

Referring to FIG. 1, a processor 100 in accordance with an illustrative embodiment will now be described. In one embodiment, the processor 100 is a pipelined processor, e.g. a reduced instruction set computing (RISC) processor, that may be provided on an integrated circuit (IC) chip (not shown). The illustrated processor 100 processes successive instructions of a program to be executed by breaking each instruction into a sequence of steps. Other embodiments may apply. For instance, the processor 100 may be embodied as a digital processing unit (DSP), a central processing unit (CPU) or in any other suitable form.

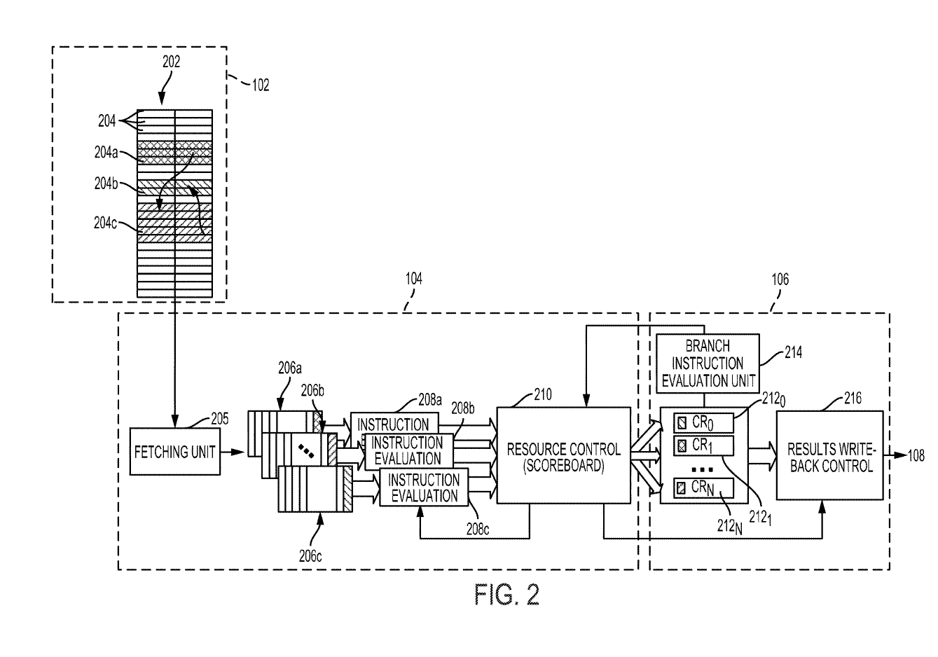

The illustrated processor 100 comprises an instruction memory 102, a pre-execution instruction pipeline 104, an execution unit 106, and data memory/registers 108. As shown in FIG. 2, in one embodiment, the instruction memory 102 comprises consecutive memory locations 202 storing a sequence (or stream) of instructions as in 204 to execute. Although the instruction memory 102 is illustrated as being part of the processor 100, it should be understood that the instruction memory 102 may be separate therefrom. Therefore, the instruction memory 102 may be cache (e.g. provided with the processor 100) or a memory external to the processor 100. The instructions 204 may be organized in the instruction memory 102 into lines or rows (or any other suitable format) and may comprise multiple branch instructions as in 204a, 204b, 204c. The branch instructions 204a, 204b, 204c may be conditional branch instructions (i.e. branch instructions that change the flow of program execution from a sequential execution path to a specific target execution path that may be taken or not depending upon a condition specified within the processor) or unconditional branch instructions (i.e. branch instructions that specify a branch in program flow that is always taken, independently of a condition within the processor). When a given conditional branch instruction is evaluated at the pre-execution instruction pipeline 104, the conditional branch instruction may be considered as either resolved (i.e. the condition upon which the branch depends is available when a given conditional branch instruction is evaluated) or unresolved (i.e. the condition is unknown prior to execution). Also, in some circumstances, given instructions as in 204 may depend on other instructions, such that the given instructions can only be executed once data for the other instructions has become available (e.g. as a result of execution of the one or more other instructions).

Examples of conditional branch instructions include, but are not limited to, if-then-else, else if, equal, less than, less or equal, greater than, greater or equal. Also, since program loops may be implemented with distinct loop instructions or using one or more branch instructions, examples of conditional branch instructions may also include loops. Examples of unconditional branch instructions include, but are not limited to, jump instructions. For instance, the instructions 204a, 204b, 204c may comprise if-else conditional branch instructions, with instructions 204a corresponding to an initial if branch, instructions 204b corresponding to the else branch associated with the initial if branch, and instructions 204c corresponding to an if branch nested within the else branch. It should be understood that, although the branch instructions 204a, 204b, 204c are discussed herein as being conditional branch instructions, unconditional branch instructions may also apply, in which case a single branch (e.g. branch to be taken) would be required as the not taken path would not exist. Thus, as used herein, the phrase “branch instruction” should be understood to refer to both conditional and unconditional (e.g. jump) branch instructions. It should also be understood that, although three (3) different branch instructions 204a, 204b, 204c (and the instruction sequences associated therewith) are illustrated in FIG. 2, the instruction memory 102 may comprise more or less branch instructions.

At the beginning of each instruction phase, the pre-execution instruction pipeline 104 retrieves a number of instructions as in 204 from the instruction memory 102. For this purpose, the pre-execution instruction pipeline 104 may comprise a fetching unit 205 that computes target addresses at which instructions are to be fetched and fetches instructions accordingly. For example, the fetching unit 205 may request a line located in the instruction memory 102 at a given target address and may accordingly receive a group of instructions stored at the requested line. Each time the fetching unit 205 detects a branch instruction in the instruction memory 102, the fetching unit 205 may then read, fetch, and store a predetermined number of instructions from each branch (e.g. the taken and not taken paths associated with the branch instruction). In one embodiment, the branch instructions as in 204a, 204b, 204c are fetched from the instruction memory 102 concurrently (e.g. in parallel) and each branch instruction 204a, 204b, 204c is stored in a buffer 206a, 206b, 206c, which may be implemented as a First-In-First-Out (FIFO) queue. In some embodiments, the branch instructions as in 204a, 204b, 204c are fetched from the instruction memory 102 simultaneously, e.g. at substantially the same time. In this manner, each buffer (e.g. buffer 206a) has stored therein an instruction stream corresponding to a given branch (e.g. the branch associated with and reached upon execution of branch instruction 204a) of the program to be executed Each buffered instruction stream may comprise a branch condition to be evaluated along with the instructions(s) to be executed upon satisfaction of the condition. In some embodiments, the branch instructions as in 204a, 204b, 204c are fetched from the instruction memory 102 sequentially.

In one embodiment, the overall instruction buffer (comprising individual buffers 206a, 206b, and 206c in which separate branch instructions are buffered) of the pre-execution instruction pipeline 104 is therefore provided with a multi-page construct with each given branch. Multiple branches of the program to be executed can thus be fetched and stored in the pipeline and can be made readily available for execution. For example, FIG. 2 illustrates a pipeline 104 having an instruction buffer that comprises three (3) different pages, which are concurrently active. Other embodiments may apply. Indeed, it should be understood that, although three (3) buffers 206a, 206b, 206c are illustrated in FIG. 2, the pre-execution instruction pipeline 104 may comprise more or less buffers depending on the number of branch instructions as in 204a, 204b, 204c present in the instruction memory 102 and retrieved therefrom for execution.

It should also be understood that the number of branches and/or instructions per branch, which are fetched and stored in the buffers 206a, 206b, 206c, depends on the size of each buffer 206a, 206b, 206c (i.e. on the FIFO depth available for storing instructions associated with a given path of a branch instruction) and/or the number of processor resources. As such, for any given branch of the program (e.g. for each instruction stream), the pre-execution instruction pipeline 104 fetches and buffers a limited number of instructions at any given time and only a given number of the fetched instructions is subsequently executed at the execution unit 106. Each buffer 206a, 206b, 206c may then be filled with newly fetched data as soon as old fetched data has been consumed (e.g. decoded, evaluated, and allocated to resources for execution, as will be discussed further below). In one embodiment, it is desirable that the number of instructions that is executed be greater than the time taken by the processor 100 to fetch an instruction. In this manner, it is possible to compensate for the program-discontinuity overhead delay to start fetching instructions from a new location. For example, if the processor 100 takes three (3) clock cycles to fetch an instruction, it is desirable for four (4) to six (6) instructions from each branch of the program to be executed at any given time.

Still referring to FIG. 2, after having been fetched and buffered, the instructions stored in each buffer 206a, 206b, 206c are decoded and evaluated in parallel, each instruction of a given instruction stream being evaluated at a given one of a plurality of instruction evaluation units 208a, 208b, 208c. In some embodiments, the buffered instructions are decoded and evaluated simultaneously, e.g. at substantially the same time. It should be understood that, in one embodiment, the instruction evaluation units as in 208a, 208b, 208c are provided in the pre-execution instruction pipeline 104 in a number equal to the number of buffers 206a, 206b, 206c, this number depending on the number of branches fetched from the instruction memory 102, as discussed above. Once the instructions have been decoded and evaluated, a centralized resource control unit (or scoreboard) 210 provided in the pre-execution instruction pipeline 104 may be used to manage allocation of the evaluated instructions to a number (N) of resources (or Computation Resources (CRs)) as in 212₀, 212₁, . . . , 212_{N} provided in the execution unit 106, each instruction being executed by a given resource 212₀, 212₁, . . . , or 212_{N}. The number (N) of resources 212₀, 212₁, . . . , or 212_{N} is dictated by processor performance and a minimal processor may comprise a single resource (as in 212₀) that performs all computations. Examples of resources 212₀, 212₁, . . . , 212_{N} include, but are not limited to, vector resources adapted to perform multiply an accumulate, arithmetic, conversion and look-up tables operations, and the like, integer resources adapted to perform arithmetic and bit manipulation, multiplication and division operations, and the like, and load and store resources. The resources 212₀, 212₁, . . . , 212_{N} may all be of a same type or of different types.

In particular, the resource control unit 210 is connected to the instruction evaluation units 208a, 208b, 208c and determines from the outputs of the instruction evaluation units 208a, 208b, 208c the type of instructions present in the pre-execution instruction pipeline 104. The resource control unit 210 then identifies the resource requirement associated with each instruction and verifies the availability of the corresponding resource(s), e.g. using a resource table or any other suitable means. Upon determining that the corresponding resource(s) are available, the resource control unit 210 assigns (e.g. dispatches or issues) the evaluated instructions to the corresponding resource(s) and updates the resource table. The resource control unit 210 can then keep track of which branches of the program are being executed at any given time. Once allocation has been performed by the resource control unit 210, all issued instructions are executed in parallel by the resources 212₀, 212₁, . . . , 212_{N} the instructions are assigned to. In one embodiment, the given resource(s) 212₀, 212₁, . . . , 212_{N} assigned to execute a given instruction are locked and only released by the resource control unit 210 when the result computed by the given resource(s) 212₀, 212₁, . . . , 212_{N} is known to be ready and the processor 100 is so notified.

The results of the operations performed by the resources 212₀, 212₁, . . . , 212_{N} may be stored in temporary registers (not shown) and the final result of each branch instruction may be stored in a data memory/instruction registers 108. In particular, the temporary registers hold speculative results until resolution of the branch(es), at which time the temporary register content is written in the data memory/instruction registers 108. Upon issuing instructions, the resource control unit 210 may thus store (e.g. in a resource table) the current context associated with the issued instructions (e.g. the dependencies and resource allocation for each instruction susceptible to create a program discontinuity). In this manner, the proper inputs can be assigned to each issued instruction for execution thereof. In particular, with knowledge of the dependencies and resource allocation, a given instruction (e.g. a post-discontinuity instruction) having an input operand depending on the result of a previous instruction (e.g. the result a pre-branch instruction executed before a branch instruction is reached) can directly read the input operand value from the temporary registers. As such, after occurrence of a program discontinuity, the processor 100 can resume its operations as soon as new instructions are decoded and assigned to available resources, thereby ensuring fast recovery from program discontinuities and improving overall processor performance.

The execution unit 106 may further comprise a branch instruction evaluation unit 214, which is connected to the resources as in 212₀, 212₁, . . . , 212_{N} and determines from the resources' outputs (i.e. the results of the operations performed by the resources 212₀, 212₁, . . . , 212_{N}) which branch is correct or successful (i.e. is to be taken) and which branch(es) are incorrect (i.e. not to be taken), thereby evaluating the truthness of the condition upon which the branch instruction depends and resolving the branch condition. For example, the branch instruction evaluation unit 214 may determine from the resources' outputs which one of the if and else branches of an if-else conditional branch instruction is correct. The branch instruction evaluation unit 214 may also determine the destination (e.g. compute the target address) to jump to. In one embodiment, for conditional branch instructions, the destination is computed by the branch instruction evaluation unit 214 as an offset to the branch instruction address. The offset may be carried in an immediate value, e.g. provided with the branch instruction's operation code (opcode). In another embodiment, for unconditional branch (e.g. jump) instructions, the destination is computed by the branch instruction evaluation unit 214 as the sum of jump instruction address and a source operand obtained from a register value. It should be understood that, although the branch instruction evaluation unit 214 is shown as an element distinct from the resources as in 212₀, 212₁, . . . , 212_{N}, the branch instruction evaluation unit 214 may be integrated with the resources 212₀, 212₁, . . . , 212_{N.}

The branch instruction evaluation unit 214 then outputs to the resource control unit 210 a signal indicative of resolution of the branch condition. This in turn causes the resource control unit 210 to output to the resources 212₀, 212₁, . . . , 212_{N} a signal comprising instructions for causing the results computed for the correct branch to be passed to the next stage (i.e. to the results write-back control unit 216) and the incorrect branch(es) (e.g. the buffer pages and temporary registers associated therewith) to be discarded from memory. In particular, incorrect (or unused) branch(es) may be fetched speculatively and dropped once it is determine that a given branch is resolved. In this case, the incorrect (or unused) need not get evaluated and can be discarded. The following nested if-else instruction sequence can be taken as an example:

| if (...) | |
|---|---|
| then A | |
| if (....) | |
| then C | |
| else D | |
| else B | (1) |

The instruction sequence in (1) above would cause the pre-execution instruction unit 104 to fetch branches A, B, C, and D in parallel. If branch A is resolved at the execution unit 106 as not taken and branch B as the correct path (i.e. the path to be taken), branches C and D may then be discarded (e.g. from the FIFO buffer pages comprising instructions yet to be executed).

The processor 100 thus reverts to its last committed register state and execution of the correct branch is continued. The results of the operation(s) performed by the resources 212₀, 212₁, . . . , 212_{N} for the correct branch are then sent to a results write-back control unit 216, which accordingly writes the instruction results to and/or updates the data memory/registers 108 (e.g. one of a plurality of registers as in 108 is updated with an instruction result), thereby updating the processor's state, which becomes the current committed register state of the processor 100. In some embodiments, the resource control unit 210 may send a control signal to the results write-back control unit 216 to instruct the latter to write the instruction results in the data memory/registers 108. In one embodiment, further to resolving the branch condition, the resource control unit 210 also outputs one or more control signals to the instruction evaluation units 208a, 208b, 208c, the signal(s) comprising instructions for preventing evaluation of any additional instruction from the instruction stream(s) associated with the incorrect branch(es) of the program.

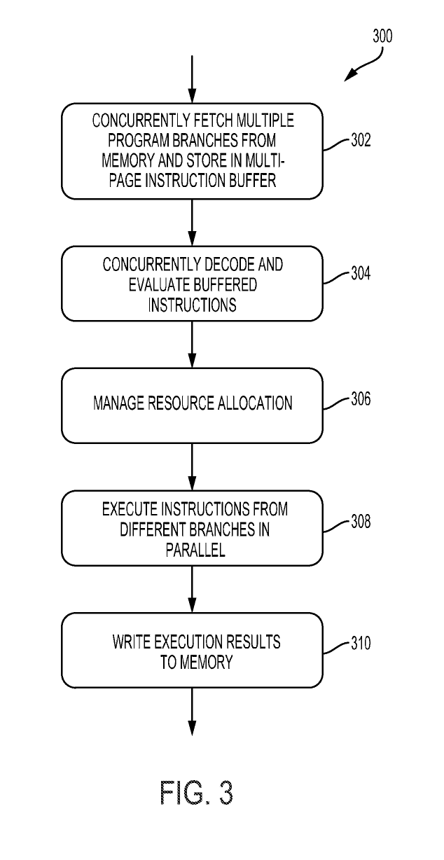

Referring now to FIG. 3, a method 300 for operating a processor as in 100 in accordance with an illustrative embodiment will now be described. The method 300 comprises, at step 302, fetching instructions in parallel, and more specifically concurrently fetching from memory multiple branches of a program to be executed. As used herein, the term “concurrently” (e.g. when used in reference to fetching, decoding, evaluating, executing instructions, and/or resolving branch condition(s)) should be understood to mean that the instructions are fetched, decoded, evaluated, executed, and/or the branch condition(s) resolved in parallel. In some embodiments, “concurrently” means that the instructions are fetched, decoded, evaluated, executed, and/or the branch condition(s) resolved in parallel and simultaneously, e.g. at substantially the same time. Step 302 further comprises storing the fetched instructions in an instruction buffer having a multi-page construct (e.g. comprising a plurality of individual buffers each representative of a page of the overall buffer). Each branch of the program is stored as a given page (i.e. in an individual buffer) of the overall instruction buffer, as discussed above with reference to FIG. 2. In this manner, the processor can store several branches of the program to be executed. As both sides of a given branch resolution are stored in the instruction pipeline and readily available for execution, this alleviates the need for branch prediction or speculation (e.g. the processor predicting the outcome of the condition upon which each branch instruction depends and executing the branch of the program the processor believes is going to be taken). The next step 304 is then to concurrently (e.g. in parallel) decode and evaluate the buffered instructions. Resource allocation is then managed at step 306 and instructions from different branches of the program are then executed in parallel at step 308. After execution of the instructions, results are written to memory (e.g. data memory/instruction registers) at step 310.

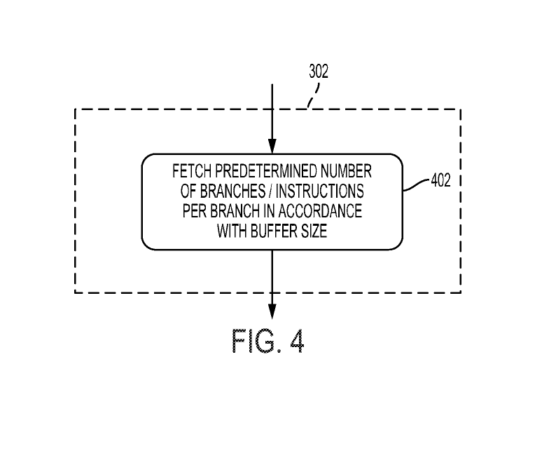

Referring to FIG. 4, the step 302 of fetching instructions from multiple branches may comprise fetching a predetermined number of branches and/or instructions per branch in accordance with the size of the multi-page instruction buffer and/or the number of processor resources. As a result, a limited number of instructions from each branch is subsequently executed at step 308. Step 402 may therefore comprise determining the size of the individual buffers of the multi-page buffer construct and accordingly determining the number of branches and/or instructions per branch to be fetched for storage in each individual buffer.

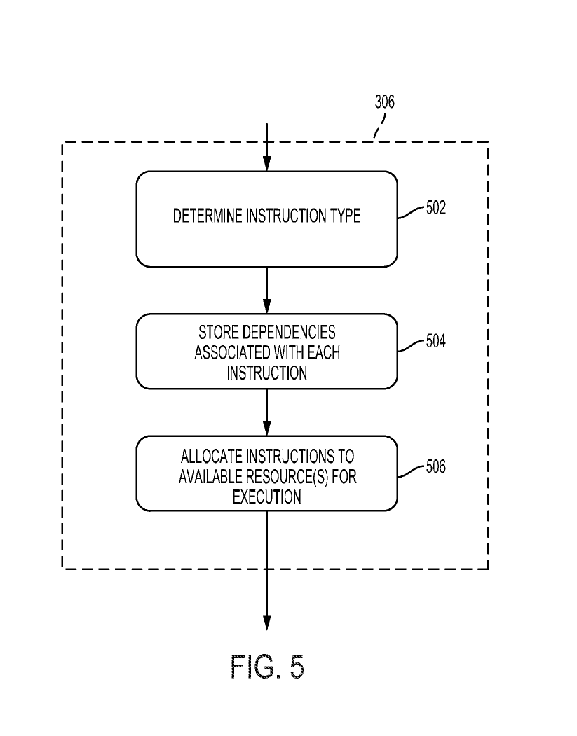

Referring to FIG. 5, the step 306 of managing resource allocation may comprise determining, at step 502, the type (e.g. conditional vs. unconditional branch instructions) of each fetched instruction and storing, at step 504, dependencies associated with each branch instruction. By performing step 504, the current context (e.g. resource allocation and register information) associated with instructions that can create program discontinuity can thus be saved. At step 506, the instructions are then allocated (e.g. issued) to available resource(s) for execution. In particular, step 506 may comprise determining the resource(s) required for each instruction, assessing whether the required resource(s) are available, routing each instruction to its required resource(s) provided the resource(s) are available, and reserving data memory and/or instruction register(s) for storing execution results therein.

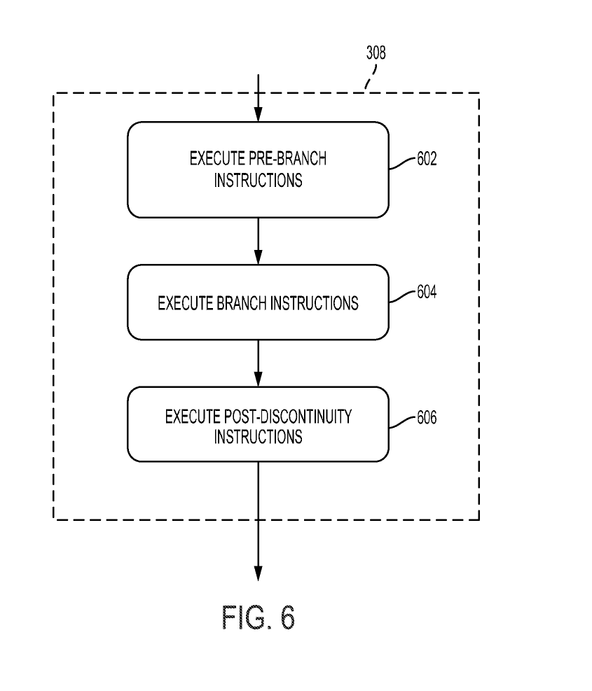

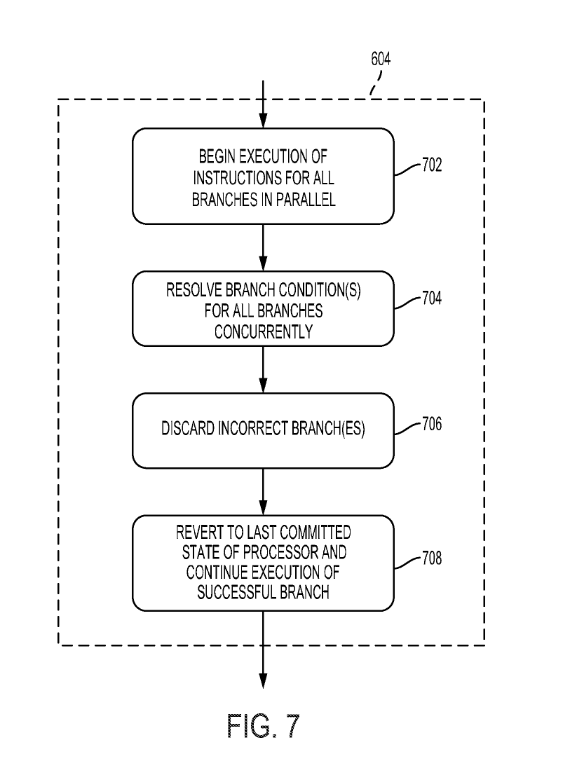

Referring to FIG. 6, the step 308 of executing instructions from different instruction streams in parallel comprises executing pre-branch instructions at step 602, executing branch instructions at step 604, and executing post-discontinuity instructions at step 606. In particular, as illustrated in FIG. 7, the step 604 of executing branch instructions comprises, at step 702, beginning execution of instructions for all branches in parallel. The branch condition(s) for all branches are then resolved concurrently at step 704 and the incorrect branch(es) can be determined accordingly. The incorrect branch(es) are then discarded at step 706 and only the successful (or correct) branch are retained. The processor then reverts to its last committed register state at step 708 and execution of the successful branch is continued, resulting in low (e.g. substantially equal to zero) overhead upon the processor switching between branches of the program.

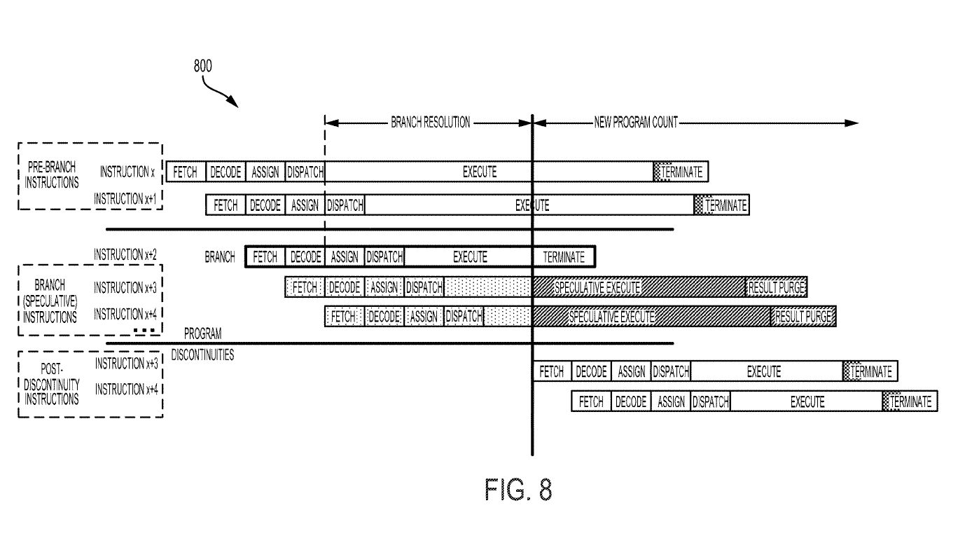

As discussed above with reference to FIG. 2, using knowledge of the dependencies (stored at step 504 of FIG. 5), post-discontinuity instruction assignment can be performed such that instructions with input operands from pre-branch instruction results can reuse temporary registers. For instance, from the stored dependencies it can be identified that a given pre-branch instruction result is an input operand to a given post-discontinuity instruction and that the given result is stored in a given temporary register. The given temporary register may then be readily accessed to provide the given result as input to the given post-discontinuity instruction. After a program discontinuity, processor operation can thus be resumed as soon as new instructions are decoded (at step 304 of FIG. 3) and assigned available resources (at step 306 of FIG. 3). This is illustrated in FIG. 8, which shows an exemplary execution 800 of a given instruction stream (labelled as the sequence of instructions x, x+1, x+2, x+3, x+4 . . . in FIG. 8) using the processor 100 of FIG. 1.

The instructions illustrated in FIG. 8 that the instructions comprise pre-branch instructions x and x+1, a branch instruction x+2, and speculative instructions x+3 and x+4. It should be understood that the exemplary execution 800 illustrated in FIG. 8 is only shown for a single instruction stream (or branch) x. As discussed herein above, the processor 100 of FIG. 1 is configured to concurrently fetch and store (in a multi-page buffer) multiple branches of a program to be executed and concurrently execute the instructions associated with the stored branches. Still, for sake of simplicity, parallel fetching and execution of multiple branches is not illustrated in FIG. 8. FIG. 8 illustrates the fact that, using the proposed processor 100 of FIG. 1, post-discontinuity instructions can be launched as soon as they are fetched (e.g. after branch resolution, as illustrated in FIG. 8) without the need for any instruction stall (e.g. while waiting for branch instruction resolution). For this purpose, the processor retrieves from a previous control resource table page the context (e.g. the and executed. When executing the post-discontinuity instructions, the processor then uses the retrieved context information to update the buffer page associated with the post-discontinuity instructions. Post-discontinuity instructions can therefore terminate earlier than with conventional processors. Using the proposed processor, program discontinuity latencies can be reduced without the need for additional hardware modules (e.g. branch predictors) in the processor and significant performance improvements (e.g. performance gains of three (3) to four (4) clock cycles in some applications) can thus be achieved.

The above description is meant to be exemplary only, and one skilled in the relevant arts will recognize that changes may be made to the embodiments described without departing from the scope of the invention disclosed. For example, the blocks and/or operations in the flowcharts and drawings described herein are for purposes of example only. There may be many variations to these blocks and/or operations without departing from the teachings of the present disclosure. For instance, the blocks may be performed in a differing order, or blocks may be added, deleted, or modified.

While illustrated in the block diagrams as groups of discrete components communicating with each other via distinct data signal connections, it will be understood by those skilled in the art that the present embodiments are provided by a combination of hardware and software components, with some components being implemented by a given function or operation of a hardware or software system, and many of the data paths illustrated being implemented by data communication within a computer application or operating system. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product may include a number of instructions that enable a computer device (personal computer, server, or network device) to execute the methods provided in the embodiments of the present invention. The structure illustrated is thus provided for efficiency of teaching the present embodiment. The present disclosure may be embodied in other specific forms without departing from the subject matter of the claims.

Also, one skilled in the relevant arts will appreciate that while the systems, methods and computer readable mediums disclosed and shown herein may comprise a specific number of elements/components, the systems, methods and computer readable mediums may be modified to include additional or fewer of such elements/components. In addition, alternatives to the examples provided above are possible in view of specific applications. For instance, emerging technologies (e.g. fifth generation (5G) and future technologies) are expected to require higher performance processors to address ever growing data bandwidth and low-latency connectivity requirements. As such, new devices will be required to be smaller, faster and more efficient. Some embodiments can specifically be designed to satisfy the various demands of such emerging technologies. Specific embodiments can specifically address silicon devices, fourth generation (4G)/5G base stations and handsets (e.g. having low-power consumption as a characteristic thereof), general processor requirements, and/or more generally the increase of processor performance. Some embodiments can also address replacement of existing network equipment and deployment of future network equipment.

The present disclosure is also intended to cover and embrace all suitable changes in technology. Modifications which fall within the scope of the present invention will be apparent to those skilled in the art, and, in light of a review of this disclosure, such modifications are intended to fall within the appended claims.

What is claimed is:

1. A system comprising:
a memory having stored therein a program comprising at least one sequence of instructions, the at least one sequence of instructions comprising a plurality of branch instructions, at least one branch of the program reached upon execution of each one of the plurality of branch instructions; and
a processor configured for:
fetching the plurality of branch instructions from the memory;
separately buffering each branch of the program associated with each one of the fetched branch instructions;
evaluating the fetched branch instructions in parallel; and
executing the evaluated branch instructions in parallel.

2. The system of claim 1, wherein the processor is configured for resolving each condition upon which the evaluated branch instructions depend and accordingly identifying, upon resolving the condition, ones of the plurality of branch instructions that are not to be taken and one of the plurality of branch instructions to be taken.

3. The system of claim 2, wherein the processor is configured for discarding the ones of the plurality of branch instructions not to be taken and carrying on with execution of the one of the plurality of branch instructions to be taken.

4. The system of claim 2, wherein the processor is configured for preventing further evaluation of the ones of the plurality of branch instructions that are not to be taken.

5. The system of claim 1, further comprising a First-In-First-Out (FIFO) buffer having a multi-page construct, wherein the processor is configured for buffering each branch of the program as an individual page of the buffer.

6. The system of claim 5, wherein the processor is configured for determining a size of the buffer and fetching a limited number of the plurality of branch instructions from the memory, the number determined in accordance with the size of the buffer.

7. The system of claim 5, wherein the processor is configured for determining a type of each one of the branch instructions, identifying selected ones of the plurality of branch instructions resulting in a program discontinuity upon the at least one branch of the program being reached, and storing resource allocation and register information associated with each selected one of the plurality of branch instructions in a corresponding page of the buffer.

8. The system of claim 7, wherein the at least one sequence of instructions comprises at least one pre-branch instruction to be executed before the at least one branch of the program is reached and at least one post-discontinuity instruction to be executed after occurrence of the program discontinuity, and further wherein the processor is configured for retrieving the stored resource allocation and register information and proceeding with execution of the at least one post-discontinuity instruction in accordance with the retrieved resource allocation and register information.

9. The system of claim 8, wherein the processor is configured for proceeding with execution of the at least one post-discontinuity instruction comprising identifying from the resource allocation and register information a result of the at least one pre-branch instruction as being an input operand for the at least one post-discontinuity instruction and a temporary register as having stored therein the pre-branch instruction result, retrieving the pre-branch instruction result from the temporary register, and providing the pre-branch instruction result as input to the at least one post-discontinuity instruction.

10. A method of operating a processor, the method comprising:
fetching a plurality of branch instructions from a memory, at least one branch of a program reach upon execution of each one of the plurality of branch instructions;
separately buffering each branch of the program associated with each one of the fetched branch instructions;
evaluating the fetched branch instructions in parallel; and
executing the evaluated branch instructions in parallel.

11. The method of claim 10, further comprising resolving each condition upon which the evaluated branch instructions depend and accordingly identifying, upon resolving the condition, ones of the plurality of branch instructions that are not to be taken and one of the plurality of branch instructions to be taken.

12. The method of claim 11, further comprising discarding the ones of the plurality of branch instructions not to be taken and carrying on with execution of the one of the plurality of branch instructions to be taken.

13. The method of claim 11, further comprising preventing further evaluation of the ones of the plurality of branch instructions that are not to be taken.

14. The method of claim 10, wherein separately buffering each branch of the program associated with each one of the fetched branch instructions comprises buffering each branch of the program as an individual page of a First-In-First-Out (FIFO) buffer having a multi-page construct.

15. The method of claim 14, further comprising determining a size of the buffer, wherein fetching the plurality of branch instructions comprises fetching a limited number of the plurality of branch instructions from a memory, the number determined in accordance with the size of the buffer.

16. The method of claim 14, further comprising determining a type of each one of the plurality of branch instructions, identifying selected ones of the plurality of branch instructions resulting in a program discontinuity upon the at least one branch of the program being reached, and storing resource allocation and register information associated with each selected one of the plurality of branch instructions in a corresponding page of the buffer.

17. The method of claim 16, further comprising retrieving the stored resource allocation and register information and proceeding with execution of at least one post-discontinuity instruction in accordance with the retrieved resource allocation and register information, the at least one post-discontinuity instruction executed after occurrence of the program discontinuity.

18. The method of claim 17, wherein proceeding with execution of the at least one post-discontinuity instruction comprises identifying from the resource allocation and register information a result of at least one pre-branch instruction as being an input operand for the at least one post-discontinuity instruction, the at least one pre-branch instruction to be executed before the at least one branch of the program is reached, and a temporary register as having stored therein the pre-branch instruction result, retrieving the pre-branch instruction result from the temporary register, and providing the pre-branch instruction result as input to the at least one post-discontinuity instruction.

19. A non-transitory computer readable medium having stored thereon program code executable by a processor for:
fetching a plurality of branch instructions from a memory, at least one branch of a program reach upon execution of each one of the plurality of branch instructions;
separately buffering each branch of the program associated with each one of the fetched branch instructions;
evaluating the fetched branch instructions in parallel; and
executing the evaluated branch instructions in parallel.
